(19) United States
(12) Patent Application Publication
(10) Pub. No.: US 2013/0103305 A1
(43) Pub. Date: Apr. 25, 2013

(54) SYSTEM FOR THE NAVIGATION OF OVERSIZED VEHICLES

(71) Applicants: Jan Becker, Palo Alto, CA (US); Oliver Schwindt, Novi, MI (US)

(72) Inventors: Jan Becker, Palo Alto, CA (US); Oliver Schwindt, Novi, MI (US)

(73) Assignee: ROBERT BOSCH GMBH, Stuttgart (DE)

(21) Appl. No.: 13/276,425

(22) Filed: Oct. 19, 2011

(51) Int. Cl. G01C 21/34

(52) U.S. Cl. 701/411; 701/527; 701/410

(57) ABSTRACT

A system for identifying a route to be traveled by an oversized vehicle. The system includes a measurement vehicle having at least one sensor attached thereto, wherein the measurement vehicle travels one or more potential routes on a roadway, and a controller in communication with the at least one sensor. The controller is configured to collect data from the at least one sensor, the data providing information regarding at least one of a location, height, shape, and classification of each of a plurality of objects on or adjacent to the roadway and generate a map of the one or more potential routes traveled by the measurement vehicle.

### BACKGROUND

The present invention relates to identifying one or more routes for an oversized vehicle to travel.

Vehicles such as trucks or other transports which are oversized or which are carrying an oversized load need to drive cautiously when traveling on roadways in order to avoid collisions with objects such as bridges, signs, trees, buildings, and curbs. Present methods of navigation and route-finding for special and oversized transports and trucks is very difficult and time-consuming and thus costly. Often, surveying crews have to drive routes in advance and/or many measurements have to be taken in order to plan a transport. The measurements are taken manually, relative to the ground, and since this is time-consuming, typically only one route is considered and measured.

### SUMMARY

In one embodiment, the invention provides a system for identifying a route to be traveled by an oversized vehicle. The system includes a measurement vehicle having at least one sensor attached thereto, wherein the measurement vehicle travels one or more potential routes on a roadway, and a controller in communication with the at least one sensor. The controller is configured to collect data from the at least one sensor, the data providing information regarding at least one of a location, height, shape, and classification of each of a plurality of objects on or adjacent to the roadway and generate a map of the one or more potential routes traveled by the measurement vehicle.

In another embodiment the invention provides a method of identifying a route to be traveled by an oversized vehicle. The method includes steps of providing a measurement vehicle having at least one sensor attached thereto; using the measurement vehicle, traveling a plurality of potential routes on a roadway; using the sensor, collecting data regarding at least one of a location, height, shape, and classification of a plurality of objects on or adjacent to the roadway along the plurality of potential routes; generating a map of the plurality of potential routes; and identifying on the map at least one of a location, height, shape, and classification for each of the plurality of objects on or adjacent to the roadway along the plurality of potential routes.

Other aspects of the invention will become apparent by consideration of the detailed description and accompanying drawings.

### BRIEF DESCRIPTION OF THE DRAWINGS

FIG. 1 shows an example map containing object dimensions and classifications for an exemplary route.

FIG. 2A shows a map of two potential routes along a series of roadways past a number of obstacles.

FIG. 2B shows the map of FIG. 2A depicting an alternative route made by combining portions of the two routes.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In various embodiments, the invention includes a system 100 for identifying and classifying objects on or in the vicinity of a roadway and using this information to determine a route for an oversized vehicle. An oversized vehicle 400 can include a vehicle with oversized dimensions, such as a large mobile crane or specialized construction vehicle, as well as a vehicle carrying a load that has oversized dimensions such as a truck carrying or towing a large object such as a manufactured home, a boat, or other large item.

In one embodiment, the system 100 includes a measurement vehicle 200 for surveying potential routes 300. The measurement vehicle 200 has one or more sensors 210 attached thereto for scanning a roadway 310 and adjacent regions 320 to identify potential obstacles 330. Possible sensors 210 include a radar system, a lidar (i.e. Light Detection And Ranging) system, a laser scanner system, and an image collection and analysis system. A given measurement vehicle 200 may include one or more sensors 210 which use the same or different sensing technologies.

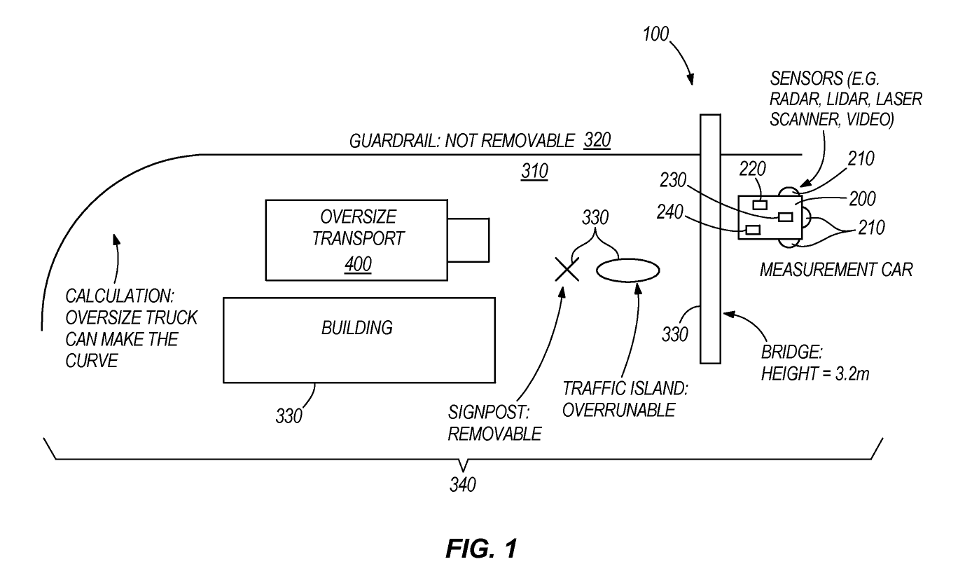

In various embodiments, the sensors 210 are attached to one or more of the front, sides, and top of the measurement vehicle 200 (FIG. 1), and can be pointed in various directions. In addition to the sensors 210, the measurement vehicle 200 in certain embodiments includes a global positioning system (GPS) unit 220 to track the location of the measurement vehicle 200 in conjunction with data collection from the sensor 210. In other embodiments, the measurement vehicle 200 may include an electronic compass 230 (which may be implemented, for example, using magnetometers or gyroscopic mechanisms) to track the orientation of the measurement vehicle 200. In addition or as an alternative to a compass 230, information regarding the orientation of the measurement vehicle 200 may be determined using other data, for example using the direction of travel indicated from data obtained from the GPS unit 220.

In some embodiments, data from the various measurement and sensing systems such as the GPS unit 220, the compass 230, and the sensors 210, is collected and stored using a computer system 240, which for illustration purposes is shown as being housed on the measurement vehicle 200. Nonetheless, the methods and systems described herein may be implemented using one or more such computer systems 240 operating in one or more remote locations. In general, the computer system 240 includes a microprocessor, memory and data storage, input and output, and wired or wireless networking capabilities and is in operative communication (wired or wireless) with the measurement and sensing systems disclosed herein. The computer system 240 serves as a controller which is configured to carry out the methods and systems disclosed herein, including controlling one or more of the sensors 210, the GPS unit 220, and the compass 230 and processing the data as described herein to provide one or more potential routes 300 on which the oversized vehicle 400 can travel.

In some embodiments the data is transmitted while being collected to a different site for storage and analysis, e.g. using radio-based communications, by a comparable computer system 240 that is remotely located. Data may be analyzed simultaneous with its collection (or near-simultaneous, using buffers to store data when the transmission signal is slowed or interrupted) or the data may be stored during collection on the computer system 240 and analyzed offline at a later time. In some embodiments, the measurement vehicle 200 may operate ‘on the fly,’ surveying roadways 310 for potential routes 300 at the same time that the oversized vehicle 400 is traveling to its destination. In still other embodiments, the oversized vehicle 400 itself includes the system 100 (including one or more of sensors 210, a GPS unit 220, a compass 230, and a computer system 240) instead of, or in addition to, the measurement vehicle 200, to continuously scan the roadway 310 for obstacles 330 during transport.

In various embodiments, the collection and analysis of data is performed by a computer system 240 that is housed on the measurement vehicle 200 in order to eliminate any delays that might occur due to data transmission or other communications problems. Nevertheless, as noted above, in other embodiments the computer system 240 may be located in a number of locations.

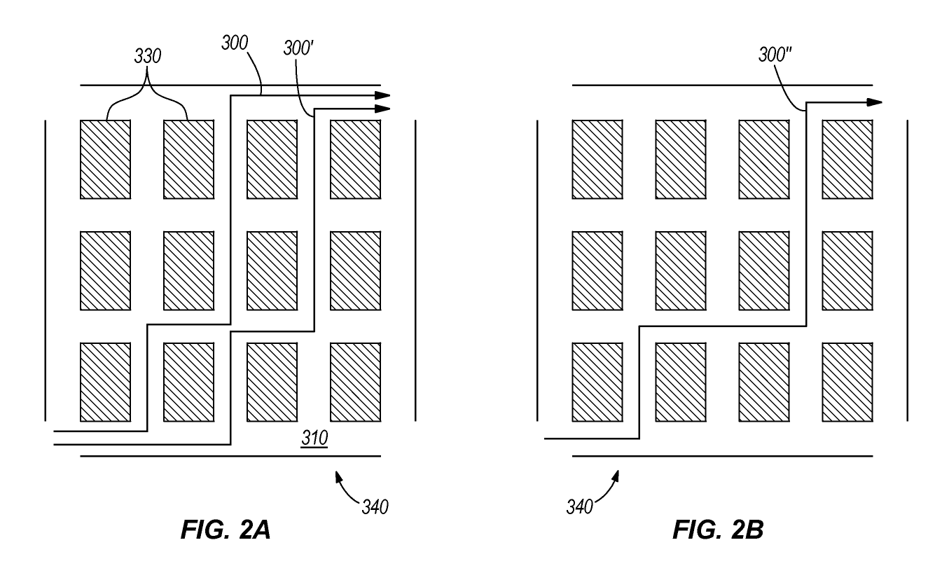

Once the starting and ending points for a given oversized vehicle 400 are determined, a set of potential routes 300 is identified either automatically by a computer mapping system or by a human operator, or by a combination of both methods. The measurement vehicle 200 is then driven along a number of the potential routes 300. While the measurement vehicle 200 is driven through the potential routes 300, data is obtained from the one or more sensors 210 on the measurement vehicle 200 to identify possible obstacles 330 along the potential routes 300, either on the roadway 310 or in the adjacent regions 320. As the measurement vehicle 200 moves it obtains data regarding the size, shape, and location of possible obstacles 330 along the potential route(s) 300. In the case where data is obtained from multiple sensors 210, a GPS unit 220, and/or a compass 230, the data from one or more of the multiple sources is combined to generate a map 340 of one or more potential routes 300. Additional potential routes 300 can be synthesized from data generated when the measurement vehicle 200 traveled particular routes, for example by combining data from segments of several different potential routes 300 traveled by the measurement vehicle 200 to generate a new route (FIGS. 2A, 2B). In some embodiments, the system 100 may determine that one or more potential routes 300 are impassible, e.g. due to considerations such as a narrow passage; a low bridge, tunnel, or overhead sign; or a turn with too small of a radius.

For each potential route 300, the system 100 generates a travel time and distance, identifies obstacles 330, estimates the cost of moving or replacing each obstacle 330, distances between obstacles 330 (e.g. width between signs), and clearances under certain obstacles (e.g. bridges) and produces an overall estimated cost associated with traveling the given route. The overall estimated cost may also take into account a per-mile (or per unit time) cost of operating the oversized vehicle 400 as well as costs of moving or replacing obstacles 330. Data for per-mile costs as well as costs of moving obstacles 330 can be provided by the system 100 as initial default values and can be updated by the operator of the system 100 with information that is specific to the oversized vehicle 400, the potential route 300, and other factors. Other considerations that the system 100 can take into account include the height and shape (e.g. square or sloped) of curbs, traffic islands, and other low-lying obstacles 330 to help determine whether such obstacles can be overrun and contours of obstacles 330 (e.g. the shape of a tunnel entrance) to determine whether the oversized vehicle 400 can move past the obstacle. For locations that are found to be too narrow to pass, the system determines whether any of the obstacles 330 that line the narrow zone can be moved and at what cost, or if one or more obstacles 330 are fixed and cannot be moved (e.g. buildings). Finally, if the dimensions of the oversized vehicle 400 change at any point before or during transport, the system 100 can recalculate the route to confirm that the present route is acceptable or to determine a new potential route 300.

For those embodiments which utilize an image collection and analysis system to collect data, the system 100 may also include image analysis software to extract information from the image data. The image analysis software may extract information about potential obstacles on or near the roadway 310 such as height, width, and location of the potential obstacle 330 relative to the roadway 310. The image analysis software may also use image recognition techniques to identify what type of object the potential obstacle 330 is and whether it is fixed or can be removed. In addition, or as an alternative, image data can be manually reviewed to identify potential obstacles 330.

Information that is extracted by the image analysis software can also be combined with data from other sensors 210 (e.g. from the radar or lidar systems) to produce more accurate information about the potential obstacle 330 including properties such as their size and location. Furthermore, image data from multiple views (e.g. from different cameras or from sequential frames obtained as the measurement vehicle travels the potential routes) can be combined to generate additional information about the roadway 310 and potential obstacles 330 and can be used to generate three-dimensional projections of the potential route 300. This three-dimensional information can also be used to improve the accuracy of location, distance, and size measurements. The image analysis software may also include procedures for calibrating image data so that actual measurements (e.g. in meters or feet) of features identified in the images can be obtained.

In various embodiments, the map 340 generated using the data collected by the measurement vehicle 200 can be combined with data from other sources including other map databases to integrate information regarding parameters such as vehicle weight restrictions, traffic patterns, road construction updates, and other factors, some of which may change over time or which may not be observable by the sensors 210 attached to the measurement vehicle 200.

In addition to measurements of the potential routes, the system 100 also includes procedures for obtaining measurements of the oversized vehicle 400 itself, including one or more of the tallest portion of the vehicle 400; the height of specific portions of the vehicle 400 (e.g. the cab, the trailer, the load, or portions thereof); the width of the widest part of the vehicle 400; the width of specific portions of the vehicle 400 (e.g. the cab, the trailer, the load or portions thereof); weight of the vehicle 400; and clearance under the vehicle 400. This information may be obtained by making manual measurements and/or by using sensors such as those used on the measurement vehicle 200. In some embodiments, the sensors 210 on the measurement vehicle 200 itself is used to obtain certain measurements (e.g. height- and width-related values) of the oversized vehicle 400.

FIG. 1 shows an example of a map 340 of a portion of a potential route 300 with the oversized vehicle 400 and the measurement vehicle 200 superimposed on the map 340. The map 340 also shows several representative potential obstacles 330 along with an identification of the type of each potential obstacle 330 as well as an indication of whether each can be removed, overrun, or navigated past. For example, the system 100 may determine that a signpost can be removed; a traffic island or a patch of grass can be overrun; that the vehicle 400 can navigate a particular curve; and that a particular guardrail would not be removable. In addition, the system 100 determines the locations of objects as well as critical dimensions (e.g. the clearance height of a bridge, the radius of curvature of a curve).

FIGS. 2A and 2B illustrate mapping of potential routes 300 and how several potential routes 300 can be combined to make another route. FIG. 2A shows a map 340 including two potential routes 300, 300′ that were traveled by the measurement vehicle 200 along a system of roadways 310 containing numerous potential obstacles 330. FIG. 2B shows the map 340 with an alternative potential route 300″ depicted thereon, where the alternative potential route 300″ is made from portions of the two potential routes 300, 300′ that were actually traveled by the measurement vehicle 200.

The system 100 and related methods disclosed herein provide a number of advantages over known systems. For example, since the measurement vehicle 200 is easily maneuverable and its measurements are automated, a number of different routes can be mapped and recorded in a relatively short time. Furthermore, the data obtained regarding potential routes 300 can be stored for future use and combined with other data to simplify future route planning

The data that can be measured potentially includes all dimensions of all possible obstacles. Image information may also be used to automatically or manually classify obstacles to determine if anything is removable (along with an estimate of the costs to remove and/or replace the obstacle), if no other option exists.

Using the disclosed methods and system, the costs of planning routes for oversized vehicles 400 will be reduced as will the potential to create damage during transport.

Thus, the invention provides, among other things, a method and system for identifying a route for an oversized vehicle. Various features and advantages of the invention are set forth in the following claims.

What is claimed is:

1. A system for identifying a route to be traveled by an oversized vehicle, comprising:
a measurement vehicle having at least one sensor attached thereto, wherein the measurement vehicle travels one or more potential routes on a roadway;
a controller in communication with the at least one sensor, the controller configured to
collect data from the at least one sensor, the data providing information regarding at least one of a location, height, shape, and classification of each of a plurality of objects on or adjacent to the roadway; and
generate a map of the one or more potential routes traveled by the measurement vehicle.

2. The system of claim 1, wherein the measurement vehicle travels a plurality of potential routes and wherein the controller is further configured to determine a route for the oversized vehicle based on at least one of travel distance, cost of travel, presence of a fixed obstacle, and a cost of removing an obstacle along each of the plurality of potential routes.

3. The system of claim 1, wherein the controller is further configured to classify each of a plurality of objects on or adjacent to the roadway to determine whether each object is fixed, removable, can be overrun, or can be navigated past.

4. The system of claim 1, wherein the at least one sensor comprises a radar system, a lidar system, a laser scanner system, and an image collection and analysis system.

5. The system of claim 1, wherein the at least one sensor comprises an image collection and analysis system, where the image collection and analysis system provides a classification for at least one object on or adjacent to the roadway.

6. The system of claim 1, wherein the measurement vehicle further has a GPS unit attached thereto.

7. The system of claim 1, wherein the measurement vehicle travels a plurality of potential routes and wherein the controller is further configured to generate a new potential route by combining at least a portion of at least two of the plurality of potential routes.

8. A method of identifying a route to be traveled by an oversized vehicle, comprising:
providing a measurement vehicle having at least one sensor attached thereto;
using the measurement vehicle, traveling a plurality of potential routes on a roadway;
using the sensor, collecting data regarding at least one of a location, height, shape, and classification of a plurality of objects on or adjacent to the roadway along the plurality of potential routes;
generating a map of the plurality of potential routes; and
identifying on the map at least one of a location, height, shape, and classification for each of the plurality of objects on or adjacent to the roadway along the plurality of potential routes.

9. The method of claim 8, further comprising:
for each of the plurality of potential routes, determining a travel distance, a cost of travel, and a presence of a fixed obstacle on the potential route; and
determining an optimal route for transporting the oversized vehicle based on at least one of the travel distance, the cost of travel, and the presence of a fixed obstacle.

10. The method of claim 8, wherein the classification for each of the plurality of objects on or adjacent to the roadway includes each object is fixed, removable, can be overrun, or can be navigated past.

11. The method of claim 8, wherein the at least one sensor comprises a radar system, a lidar system, a laser scanner system, and an image collection and analysis system.

12. The method of claim 8, wherein the at least one sensor comprises an image collection and analysis system, where the image collection and analysis system provides a classification for at least one object on or adjacent to the roadway.

13. The method of claim 8, wherein the measurement vehicle further has a GPS unit attached thereto.

14. The method of claim 8, further comprising determining an optimal route for the oversized vehicle based on a cost of removing an obstacle.

15. The method of claim 8, further comprising generating a new potential route by combining at least a portion of at least two of the plurality of potential routes.
